(19) United States
(12) Patent Application Publication
(10) Pub. No.: US 2023/0249439 A1
(43) Pub. Date: Aug. 10, 2023

(54) AUTOMOTIVE LAMINATE WITH ELECTROACOUSTIC TRANSDUCER

(71) Applicant: AGP America S.A., Ciudad de Panamá (PA)

(72) Inventors: Mario Arturo MANNHEIM ASTETE, Lima (PE); Alfredo Daniel KOC LI, Lima (PE)

(21) Appl. No.: 18/004,674

(22) PCT Filed: Jul. 9, 2021
(86) PCT No.: PCT/IB2021/056206

§ 371 Date: Jan. 8, 2023

Related U.S. Application Data
(60) Provisional application No. 63/050,705, filed on Jul. 10, 2020.

(51) Int. Cl. B32B 17/10; B08B 7/02; B60S 1/02; H04R 17/00; H04R 7/10; H04R 3/00; B32B 7/12; B32B 3/26

(52) U.S. Cl. CPC B32B 17/10376; B08B 7/026; B60S 1/02; H04R 17/00; H04R 7/10; H04R 3/00; B32B 17/10036; B32B 7/12; B32B 3/266; B32B 17/10174; B32B 17/10761; B32B 17/10293; B60J 1/001

(57) ABSTRACT

One of the problems is the reduction in interior areas and surfaces where various types of devices can be mounted. To address this issue more and more of these devices are being integrated with the glazing. Laminated glazing is especially suitable for thin devices. Today, laminated glazing is produced with heating elements, antennas, lighting, touch sensors, RFID, electronic blinds and other types of devices integrated as a permanent part of the glazing. The invention comprises an automotive laminate with a thin integrated electroacoustic transducer integrated in the glazing.

### FIELD OF THE INVENTION

This invention relates to the field of automotive laminated glazing.

### BACKGROUND OF THE INVENTION

In response to the regulatory requirements for increased automotive fuel efficiency as well as the growing public awareness and demand for environmentally friendly products, automotive original equipment manufacturers, around the world, have been working to improve the efficiency of their vehicles.

One of the key elements of this strategy to improve efficiency has been to increase the glazed area of the vehicle. There are two reasons for this. For one, by making the glazed body openings larger, the increase in the glazed area tends to offset heavier materials, such as sheet metal, reducing weight. Also, as the average vehicle interior volume has been decreasing, consumers have found that this can result in an uncomfortable claustrophobic effect. By increasing the amount of natural light and expanding the occupant's view of the exterior this effect can be offset and compensated for.

The popular large glass panoramic roofs and windshields are just one example of this trend. A panoramic roof is a roof that covers the front seats as well as a substantial portion of the rear seats. A panoramic windshield is a windshield on which the top edge has been substantially extended such that it comprises a portion of the vehicle roof.

As the glazed area of vehicles has been increasing one of the problems encountered has been the corresponding reduction in interior area and surfaces where various types of devices, once concealed behind interior trim panels, can be mounted. As an example, most vehicles used to have a center mounted “dome” light. Even with the introduction of sunroofs, the dome lights remained. However, with the introduction of large panoramic glass roofs, covering both the front driver and passenger position as well as a portion of the rear seating, there was no longer any place to mount a light. While it was possible to mount a light on the glass, a wire cover was needed to hide the electrical wires and on a movable glass panel, the electrical connection became much more complicated. As a result, lights were placed above the doors.

In addition to lighting, the increase in the glazed area has also forced the relocation of many other devices that were formerly hidden behind interior body panels.

To address this issue, more and more of these devices are being integrated with the glazing. Laminated glazing, comprised of two glass layers with a thin plastic layer holding the two glass layers together, is especially suitable for thin devices. Today, laminated glazing is produced with heating elements, antennas, lighting, touch sensors, RFID, electronic blinds and other types of devices integrated as a permanent part of the glazing.

Electroacoustic transducers (speakers), that convert an electrical signal into sound, have traditionally been primarily been used by the entertainment system. For many years this was just an AM radio. The AM radio from the early days of the industry has evolved into a complex multifunction system providing reception across several bands including satellite reception, telephone reception, global positioning navigation, internet access, playback of recordings, camera displays, safety warnings, active noise cancellation, controls for various other devices and more.

The speakers once used exclusively for the playback of recorded material and to listen to AM/FM radio reception are now used for many of these other functions and devices. The single speaker used for an AM radio gave way to systems with two to four speakers for stereo FM reception. High end systems used multiple speakers throughout the cabin to provide optimum sound quality for each occupant. The warnings and audible alerts are now often provided through the vehicle speaker system as spoken words. Turn by turn spoken direction are standard for global positioning navigation systems and also use the vehicle speaker system as do the collision prevention safety systems. Another use for these systems is that the transducers provide sound for active sound design (ASD), giving the vehicle its own recognizable voice.

This proliferation of electroacoustic transducers has also been impacted by the increase in the area of the glazing.

Some attempts have been made to utilize the glazing as a part of the vehicle sound reception system. They have generally utilized transducers mounted to the edge or one of the surfaces of the glazing. The transducer causes the glass to vibrate and emit sound waves. This has not seen wide acceptance in the industry. The cost to produce is relatively high, the transducer increase weight and take up space, they must be hidden and transmission through the glass is less than optimal especially with the dampening effect of the plastic interlayer used to make laminated glazing.

With less and less interior area available it would be of great benefit to have the option of integrating an electroacoustic transducer with the glazing.

### BRIEF SUMMARY OF THE INVENTION

Much progress has been made in recent years in the development of thin electroacoustic transducers which today are found in almost all smart phones, laptops, tablets and in many appliances. Improvements include but are not limited to a reduction in thickness to a fraction of a millimeter, improved frequency response and range, lower cost, lower distortion, improve durability and higher efficiency. This is especially true of the piezoelectric based electroacoustic transducers.

The invention comprises an automotive laminate with at least one thin integrated electroacoustic transducer laminated between the two glass layers of the glazing. As the electroacoustic transducer is comprised primarily if not completely of inorganic materials, it can easily survive the standard automotive lamination process.

Very thin transducers can be bonded to the glass surface and laminated with a single layer of PVB plastic bonding interlayer. Thicker transducers may require that holes be made in the PVB. Two layers of PVB may also be used with the transducer placed between two PVB plastic bonding interlayers. Depending upon thickness, even with two PVB plastic bonding interlayers, a hole may be needed in at least one of the interlayers.

The transducers may be bonded to at least one of the glass layers. An adhesive having a density that matches that of the glass layer may be used to facilitate the transfer of vibration to the glass and vehicle interior.

### ADVANTAGES

Transducers are hidden.
Lower cost than individually mounted conventional speakers.
Reduced part count.
More design flexibility.
Closer to occupant ears when mounted in roof.
Replacement for tweeters.
Very effective for active noise cancellation in roof and sidelite.

### BRIEF DESCRIPTION OF THE SEVERAL VIEWS OF THE DRAWINGS

FIG. 1A shows the cross section of a typical laminated automotive glazing.

FIG. 1B shows the cross section of a typical laminated automotive glazing with performance film and coating.

FIG. 1C shows the cross section of a typical tempered monolithic automotive glazing.

FIG. 2 shows the exploded view of a laminate with three PVB interlayers and holes in middle of the PVB interlayer.

FIG. 3 shows the exploded view of laminate with two PVB interlayers, no adhesive, and no holes.

FIG. 4 shows the exploded view of laminate with two PVB interlayers, holes in the middle PVB interlayer and adhesive.

FIG. 5 shows the exploded view of laminate with one PVB interlayer, holes in the middle PVB interlayer and two adhesive layers.

FIG. 6 shows the top view of a panoramic roof.

FIG. 7A shows the section AA of a laminate with three PVB interlayers and holes in middle PVB interlayer.

FIG. 7B shows the section AA of a laminate with two PVB interlayers, no adhesive and no holes.

FIG. 8A shows the section AA of q laminate with two PVB interlayers, holes in the middle PVB layer and adhesive.

FIG. 8B shows the section AA of a laminate with one PVB interlayer, holes in the middle PVB layer and two adhesive layers.

FIG. 9A shows the transducer with a cable and a connector.

FIG. 9B shows the section BB of a transducer cable.

FIG. 9C shows the section CC of a transducer cable.

FIG. 10A shows four transducers with individual leads.

FIG. 10B shows four transducers connected with embedded wire.

FIG. 11A shows four transducers mounted to a flexible circuit.

FIG. 11B shows four transducers connected by means of a conductive coating.

### REFERENCE NUMERALS OF DRAWINGS

2 Glass
4 Bonding/Adhesive layer/Plastic Interlayer/PVB plastic interlayer
6 Obscuration/Black Paint
12 Performance film
14 Lens
16 Camera
20 Infrared reflecting coating
22 Hole
24 Transducer
26 Adhesive
28 Insulator
30 Cable
32 Conductor
36 Adhesive
38 Edge of glass
40 Release backing
42 Wire
44 Flexible Circuit
46 Conductive Coating
48 Connector
101 Exterior side of glass layer 1 (201), number one surface/Surface one
102 Interior side of glass layer 1 (201), number two surface/Surface two
103 Exterior side of glass layer 2 (202), number 3 surface/Surface three
104 Interior side of glass layer 2 (202), number 4 surface/Surface four
201 Outer glass layer
202 Inner glass layer

### DETAILED DESCRIPTION OF THE INVENTION

The following terminology is used to describe the laminated glazing of the invention.

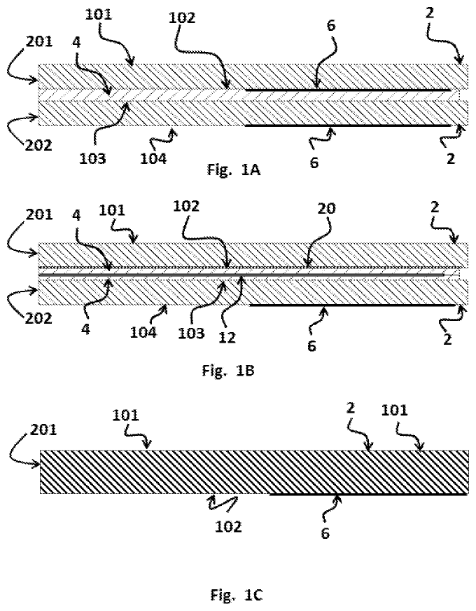

Typical automotive laminated glazing cross sections are illustrated in FIGS. 1A and 1B. A laminate is comprised of two layers of glass, the exterior or outer 201 and interior or inner 202 that are permanently bonded together by a plastic layer or interlayer 4. In a laminate, the glass surface that faces the exterior side of the vehicle is referred to as surface one 101 or the number one surface. The opposite face of the exterior glass layer 201 is surface two 102 or the number two surface. The glass 2 surface that faces the interior of the vehicle is referred to as surface four 104 or the number four surface. The opposite face of the interior layer of glass 202 is surface three 103 or the number three surface. Surfaces two 102 and three 103 are bonded together by the plastic interlayer 4. An obscuration 6 may be also applied to the glass. Obscurations are commonly comprised of black enamel frit printed on either the number two 102 or number four surface 104 or on both. The laminate may have a coating 20 on one or more of the surfaces (not shown in the figures but should schematically be noted as a line on the glass surface representing the coating over the surface). The laminate may also comprise a performance film 12 laminated between at least two plastic layers 4.

FIG. 1C shows a typical tempered automotive glazing cross section. Tempered glazing is typically comprised of a single layer of glass 201 which has been heat strengthened. The glass surface that is on the exterior of the vehicle is referred to as surface one 101 or the number one surface. The opposite face of the exterior glass layer 201 is surface two 102 or the number two surface. The number two surface 102 of a tempered glazing is on the interior of the vehicle. An obscuration 6 may be also applied to the glass.

Obscurations are commonly comprised of black enamel frit printed on the number two 102 surface. The glazing may have a coating (not shown) on the number one 101 and/or number two 102 surfaces.

The term “glass” can be applied to many inorganic materials, including many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid. A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

Laminates, in general, are articles comprised of multiple layers of thin, relative to their length and width, material, with each thin layer having two oppositely disposed major faces, typically of relatively uniform thickness, which are permanently bonded to one and other across at least one major face of each layer. The layers of a laminate may alternately be described as sheets or plies. In addition, the glass layers may also be referred to as panes.

Laminated safety glass is made by bonding two layers, the outer glass layer 201 and the inner glass layer 202 of annealed glass 2 together using a plastic bonding layer comprised of a thin sheet of transparent thermoplastic 4 (interlayer) as shown in FIG. 1A.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic interlayer 4 also helps to prevent penetration by objects striking the laminate from the exterior and in the event of a crash occupant retention is improved.

The types of glass that may be used include but are not limited to: the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings. The plastic bonding interlayer 4 has the primary function of bonding the major faces of adjacent layers to each other. The material selected is typically a clear thermoset plastic.

For automotive use, the most commonly used bonding interlayer 4 is polyvinyl butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over a wide range over the temperature range required for an automobile. Only a small number of plasticizers are used. They are typically linear dicarboxylic esters. Two in common use are di-n-hexyl adipate and tetra-ethylene glycol di-n-heptanoate. A typical automotive PVB interlayer is comprised of 30-40% plasticizer by weight.

In addition to polyvinyl butyl, ionoplast polymers, ethylene vinyl acetate (EVA), cast in place (CIP) liquid resin and thermoplastic polyurethane (TPU) can also be used. Automotive interlayers are made by an extrusion process which has a thickness tolerance and process variation. As a smooth surface tends to stick to the glass, making it difficult to position on the glass and to trap air, to facilitate the handling of the plastic sheet and the removal or air (deairing) from the laminate, the surface of the plastic is normally embossed contributing additional variation to the sheet. Standard thicknesses for automotive PVB interlayer at 0.38 mm and 0.76 mm (15 and 30 mil).

Interlayers are available with enhanced capabilities beyond bonding the glass layers together. The invention may include interlayers designed to dampen sound. Such interlayers are comprised whole or in part of a layer of plastic that is softer and more flexible than that normally used. The interlayer may also be of a type which has solar attenuating properties.

A wide variety of films are available that can be incorporated into a laminate. The uses for these films include but are not limited to: solar control, variable light transmission, increased stiffness, increased structural integrity, improved penetration resistance, 15 improved occupant retention, providing a barrier, tint, providing a sunshade, color correction, and as a substrate for functional and aesthetic graphics. The term “film” shall include these as well as other products that may be developed or which are currently available which enhance the performance, function, aesthetics, or cost of a laminated glazing. Most films do not have adhesive properties. To incorporate into a laminate, sheets of plastic interlayer are needed on each side of the film to bond the film to the other layers of the laminate.

The beltline is the line formed by the lower visible edge of the vehicle glazing. The beltline of the vehicle front and rear doors is the portion where the door window seals come into contact with the glass. The portion of the door glazing that is below the beltline is not visible.

A transducer is a device which converts one form of energy to another. An electroacoustic transducer converts an electrical signal into sound. Loudspeakers are a type of electroacoustic transducer. The typical loudspeaker utilized a permanent magnet and a coil of wire, the voice coil, that the electrical signal passes through. As the amplitude and frequency of the signal vary, an electromagnetic field is produced in the voice coil which then pushes and pulls against the force of the permanent magnet. The coil is attached to a rigid material which then sets up acoustic waves of the same frequency which we perceive as sound.

In a similar manner, sound can be produced without the use of a magnet. Electrostatic speakers apply a DC voltage to two parallel panels. The electrical signal is then applied to a thin conductive sheet, suspended between the two charged surfaces. The time varying electrical charge pushes and pulls against the positive and negative charges setting up vibrations.

Both of these technologies can be used to produce electroacoustic transducers that are small enough to fit inside of an ear. However, no means have been found to produce an effective transducer thin enough to be laminated in an automotive glazing.

Another technology makes use of the physical phenomenon that some crystals exhibit wherein they change dimensionally in response to an electrical signal. This is known as at the piezo electric effect. The effect works in both directions. A time varying electrical signal will be converted to sound and sound will be converted to electricity. In this manner, it is possible for the same transducer to serve as both a speaker and as a microphone.

An important characteristic of piezoelectric transducers is that they can be made very thin. Transducers as thin as 200 microns are known, and they can be made even thinner. The primary tradeoff being in the power output and frequency response.

To embed an object within a laminate, the object must be very thin and uniform. As a general rule of thumb, a film, busbar, sensor, wire, lead or other object can be laminated if the thickness is not more than ⅓ of the total thickness of the interlayer. The interlayer is soft at room temperature. During the lamination process, the interlayer is treated at an elevated temperature and will flow to accommodate the added object if the object is thin enough. The maximum thickness will depend upon other factors such as the other dimensions of the object, the thickness of the glass, the strength of the glass, the specific interlayer and the time, temperature and pressure of the lamination cycle. If the object is too thick, the glass may break. Objectionable distortion can also occur. With all other factors remaining the same, thinner is always better with respect to the risk of breakage and distortion.

A typical automotive laminate will have a plastic interlayer with a thickness of 0.76 mm. This will accommodate, at best, an object with a uniform thickness of 250 microns. As piezo electric electroacoustic transducers as thin at 200 microns are available, it may be possible to laminate such a transducer with no modification to the laminate.

To produce such a laminate, the transducer is first bonded to the inner glass layer. To maximize the transfer of power, an adhesive that is matched to the density of the glass is preferred such as a glass filled epoxy or urethane. The interlayer is placed over the transducer and the assembly is processed to produce the final laminate.

If the transducer is thicker, up to the thickness of the interlayer, or does not otherwise result in a successful laminate, a hole can be made in the interlayer. In this case, the steps remain the same with the transducer bonded to the interior glass layer, but the opposite side must also be bonded to the exterior surface. The adhesive is also needed not only to bond the transducer to the outer glass but to fill any gap if the transducer thickness is less than that of the interlayer. Otherwise, the pressure applied during the lamination process will cause the glass to deflect and to break.

On many laminates, two or more interlayers are used. This is usually done to integrate a performance film into the laminate. In this case, a very thin transducer can be bonded to the inner glass layer and laminated or placed between the two layers of interlayer.

When placed between the two interlayers, some loss of power will be experienced due to the mismatch in density between the interlayer and the glass. This can be overcome by bonding directly to the inner glass surface as mentioned. For a thicker transducer, a hole can be made in the layer of interlayer facing the inner glass layer. No adhesive is required on the opposite side of the transducer but if significantly thinner than the interlayer, a spacer may be needed to prevent breakage during the lamination process. Such a spacer must be bonded to the transducer. A thin layer of interlayer may be used which will bond to the adjacent interlayer and to the transducer.

As the transducers are opaque, they will generally be mounted in a portion of the glass that is hidden or covered with an opaque obscuration. On a panoramic roof it is common to have a wide black paint band around the periphery. On a door laminate, the transducer may be mounted just below the beltline.

The transducer can be produced with a pattern or solid color if it needs to be placed in the clear portion of the glazing where it will be visible. The pattern or color can be matched to the vehicle trim on the interior side and to the vehicle paint color on the exterior side becoming a design feature.

Compared to magnetic or electrostatic transducers, piezoelectric transducers are relatively simple and inexpensive to produce. At a minimum they comprise two electrode layers sandwiching a piezo crystal layer. They can be made very thin, unlike the other types of transducers. Even at their thinnest, the surface area can be comparatively large, enabling them to emit at higher power. Unlike the other technologies, they do not require a cross over network, to prevent out of range frequencies from being applied which can damage the other types of transducers. They are also self-limiting in that they cannot be overloaded. The crystal layers will expand or contract to a certain limit and applying more power does nothing. This is the leading cause of failure in conventional magnetic and electrostatic transducers.

Due to the simple construction, they can be produced inexpensively with little labor required. Thin piezoelectric electroacoustic transducers are used in almost every single computer, laptop, table, smart phone, and many appliances. Due to the volume, highly automated factories have been built to produce them.

Multiple transducers can be integrated into a single glazing. As they are a permanent part of the glazing, there will only be one part number, that of the glazing. The separate part numbers for the separate components are eliminated for further savings from inventory management.

Any convenient method may be used to make the electrical connection including but not limited to individual leads, discrete embedded wires, a conductive coating, or a flexible circuit. Multiple transducers may be connected in series or in parallel. As a variety of equivalent means may be used to connect the transducers, the actual wiring is not shown in the drawings.

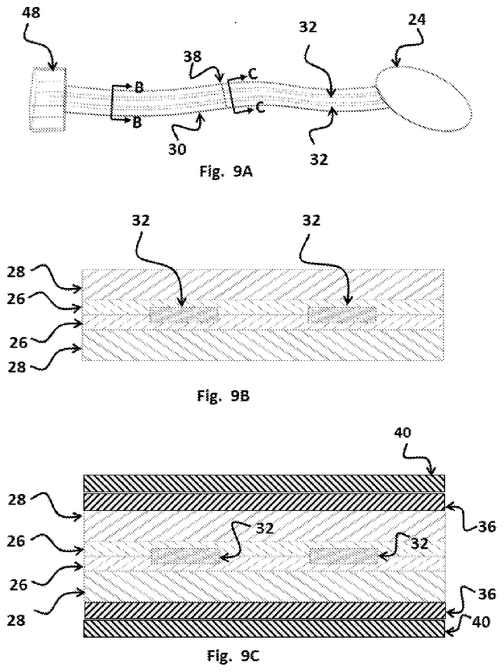

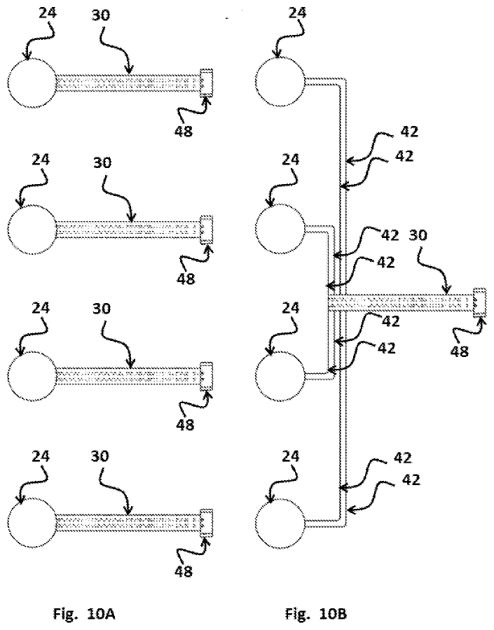

Two conductors are needed to connect the transducer to the electrical signal. A typical transducer with lead is illustrated in FIGS. 9A, 9B, 9C and 10A. Two 3 mm wide 2 oz copper conductors 32 are encapsulated by two layers of adhesive backed polyamide tape 30. The polyamide 28 is 50 microns thick and the acrylic adhesive 26 backing is 25 microns thick. This gives a total thickness that can be accommodated and successfully laminated on most laminates with a single 0.76 mm plastic interlayer. From the portion of the lead that extends inboard from the edge of glass 38, two additional adhesive layers are added. This is a different type of adhesive 36. The adhesive is used to attach the lead to the glass and/or the plastic interlayer 4 during assembly of the laminate. A paper release backing 40 is removed at the time of assembly. Both layers may not be needed depending upon the application.

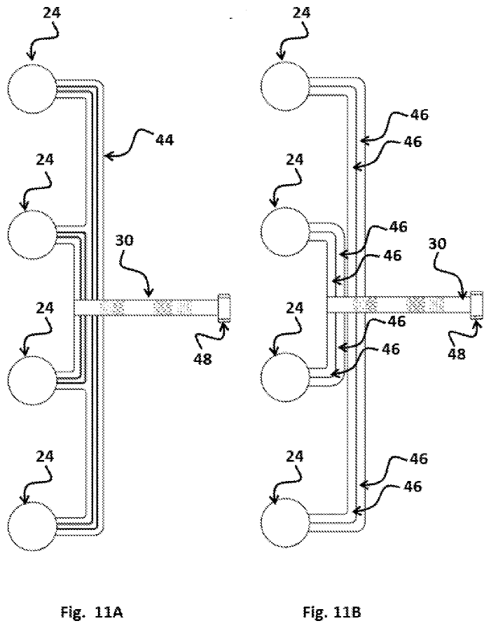

If the laminated is provided with a conductive coating 46, the coating itself may be used to provide power to the transducers as shown in FIG. 11B. This option of course will depend upon the operating voltage range, the power required, the conductivity of the coating and the length of the available path for the current. The circuit is formed by means of LASER ablation of the coating. Other methods such as etching, and masking and others may also be used. Contact is made by direct DC contact or by means of a conductive adhesive or other type of media such as a powdered conductive past.

Embedded wire heating and antenna elements have been known in the art. Wires 42 embedded in the plastic interlayer may also be used to provide for the electrical connection to the transducers as illustrated in FIG. 10B. The wires are substantially thinner than the interlayer thickness. Heat or ultrasound is used to embed the wire in the plastic interlayer. The wires are soldered or mechanically electrically connected to the transducers.

Perhaps one of the best options is that of a flexible circuit 44. Flexible circuits 44 are commonly used in almost all complex electronic devices. They are essentially a printed circuit produced on a thin flexible substrate. The transducers can be pre-attached to the flexible circuit simplifying assembly and reducing cost. Multiple transducers can be mounted to a single flexible circuit and the connections brought out from the edge of glass in a single lead as shown in FIG. 11A.

Rather than being limited to just the areas of the vehicle having interior trim, the designer and engineer can place the transducer at its best location. For driver alerts, warnings, and directions, rather than providing over the vehicle speaker system, they can be directed to transducers in the roof, close to the driver's ears. As the transducers work both ways, they can also serve as microphone to provide verbal commands to the vehicle. By placing them closer to the driver they are less likely to be interfered with by other noise that may be present.

Active noise cancellation is being used in some higher end vehicles. One of the drawbacks of a glass roof over a conventional roof is that even with a laminated roof glazing more sound is transmitted through the glass than with a metal roof and headliner. By using transducers mounted in the glass roof, the noise can be canceled out at the source. The transducers can also be used to cancel out cabin noise from other sources as well.

A car active sound design (ASD) is automotive audio application in which specific sounds are generated based on various parameters. In some vehicles the sound of the engine can be generated based on parameters like speed or throttle. In other vehicles, a voice specific to the vehicle can be generated.

Ultrasonic transducers are also used to clean surfaces from contamination. Transducers shake the glass, so that rain, snow, mud, dust, or debris, do not stick to its surface.

### DESCRIPTION OF EMBODIMENTS

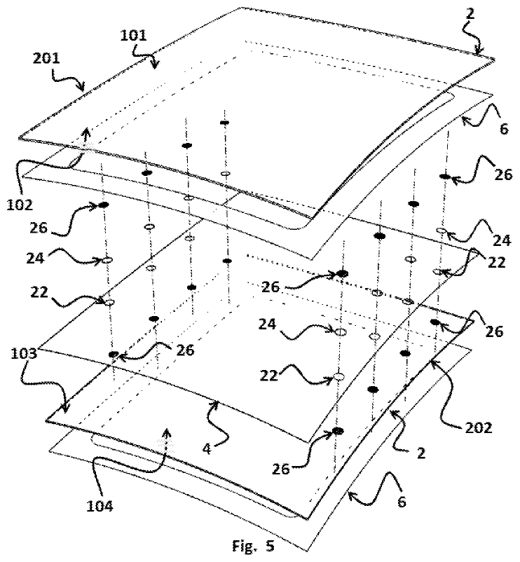

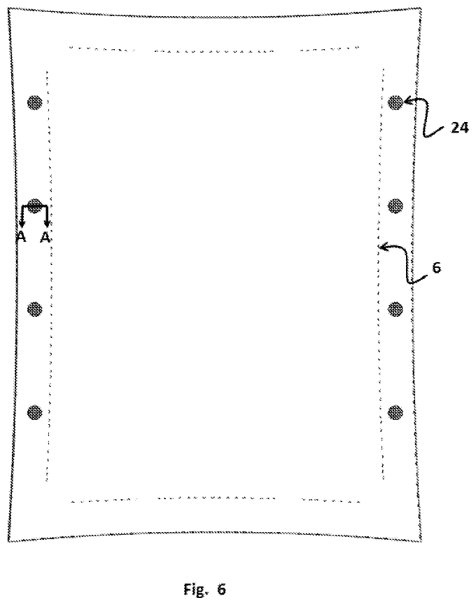

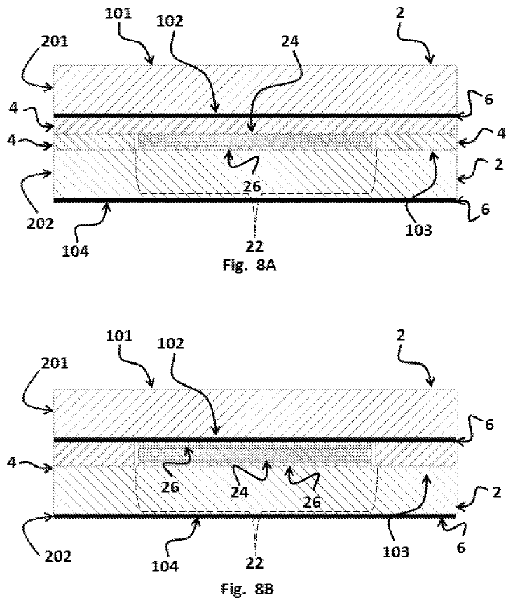

Embodiment 1 is the panoramic laminated roof shown in FIG. 6. The inner 202 and outer glass 201 layers are comprised of 2.3 mm solar grey soda-lime glass. The outer glass layer 201 is painted on surface two with a black enamel frit obscuration 6. The inner glass layer 202 is painted on surface four. The two glass layers are bent by means of a hybrid full surface press gravity bending process. A single 0.76 mm thick grey PVB plastic interlayer 4 is used to bond the two glass layers together. The total visible light transmission of the laminate is 20%. Eight 600 microns thick, 50 mm diameter, piezo, electroacoustic transducers 24 are integrated in the laminate as shown. Cross section AA is shown in FIG. 8B and an exploded view in FIG. 5. Due to the thickness of the transducer 24, holes 22 are made in the interlayer 4. A glass filled urethane adhesive 26 is used to bond the transducer to the inner glass layer 201. A urethane adhesive 26 bonds the transducer to the outer glass layer 202.

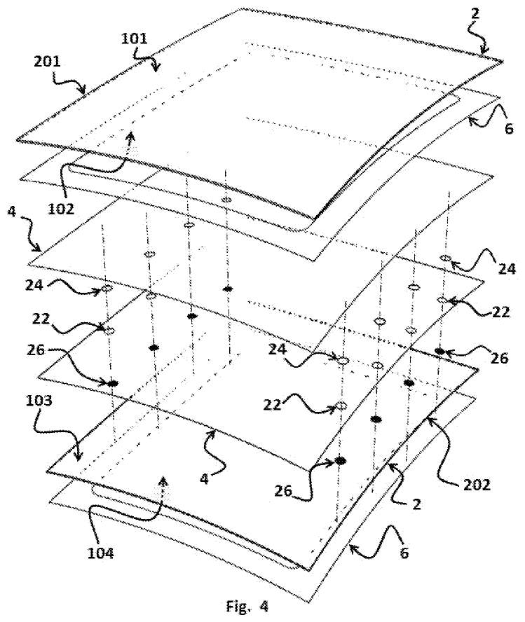

Embodiment 2 is the panoramic laminated roof shown in FIG. 4. The inner 202 and outer glass 201 layers are comprised of 2.3 mm solar grey soda-lime glass. The outer glass layer 201 is painted on surface two 102 with a black enamel frit obscuration 6. The inner glass layer 202 is painted on surface four 104. The two glass layers are bent by means of a hybrid full surface press gravity bending process. Two 0.76 mm thick grey PVB plastic interlayer 4 are used to bond the two glass layers together. The total visible light transmission of the laminate is 20%. Eight 600 microns thick, 50 mm diameter, piezo, electroacoustic transducers 24 are integrated in the laminate as shown. Cross section AA is shown in FIG. 8A and an exploded view in FIG. 4. Due to the thickness of the transducer 24, holes 22 are made in the plastic interlayer 4 adjacent to and bonding surface 3 103 of the inner glass layer 202. A glass filled urethane adhesive 26 is used to bond the transducer to the inner glass layer 201. The second PVB plastic interlayer 4 bonds the transducer to the outer glass layer 202.

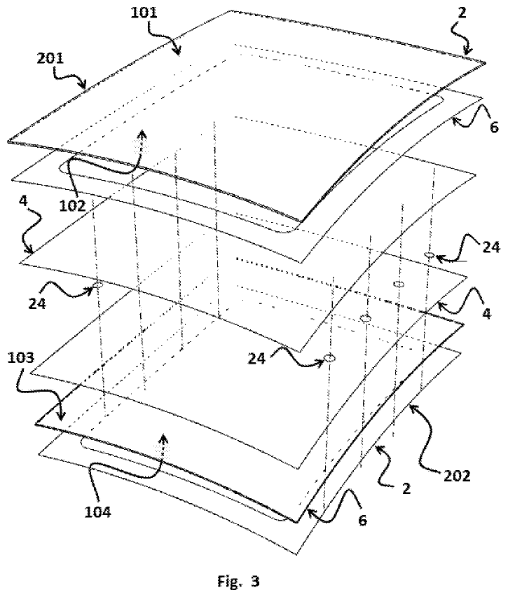

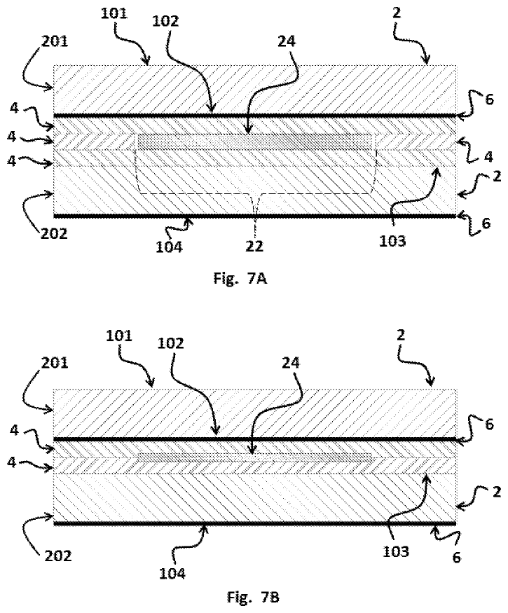

Embodiment 3 is the panoramic laminated roof shown in FIG. 3. The inner 202 and outer glass 201 layers are comprised of 2.3 mm solar grey soda-lime glass. The outer glass layer 201 is painted on surface two 102 with a black enamel frit obscuration 6. The inner glass layer 202 is painted on surface four 104. The two glass layers are bent by means of a hybrid full surface press gravity bending process. Two 0.76 mm thick grey PVB plastic interlayer 4 are used to bond the two glass layers together. The total visible light transmission of the laminate is 20%. Eight 400 microns thick, 50 mm diameter, piezo, electroacoustic transducers 24 are integrated in the laminate as shown. Cross section AA is shown in FIG. 7B and an exploded view in FIG. 3.

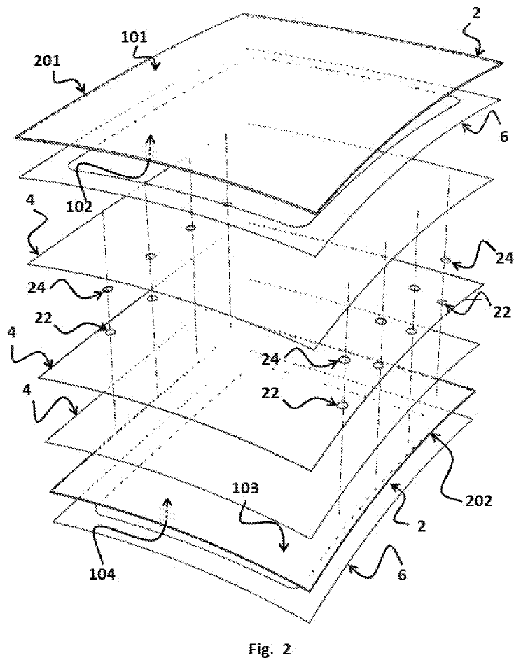

Embodiment 4 is the panoramic laminated roof shown in FIG. 2. The inner 202 and outer glass 201 layers are comprised of 2.3 mm solar grey soda-lime glass. The outer glass layer 201 is painted on surface two 102 with a black enamel frit obscuration 6. The inner glass layer 202 is painted on surface four 104. The two glass layers are bent by means of a hybrid full surface press gravity bending process. Three 0.76 mm thick grey PVB plastic interlayers 4 are used to bond the two glass layers together. The total visible light transmission of the laminate is 20%. Eight 800 microns thick, 50 mm diameter, piezo, electroacoustic transducers 24 are integrated in the laminate as shown. Cross section AA is shown in FIG. 7A and an exploded view in FIG. 2. Due to the thickness of the transducer, holes 22 are made in the middle interlayer 4. No adhesive is used as the transducer is sandwiched between two PVB interlayers 4. Besides the specific description of this embodiment, it should be noted that multiple plastic interlayers 4 can be used and holes 22 can be produced in any of the plastic interlayers 4 indistinctly.

Embodiments 1, 2, 3 and 4 make use of two lead conductors for each transducer for a total of eight leads as shown in FIG. 10A.

Embodiments 5, 6, 7 and 8 are the same as 1, 2, 3 and 4 with the exception of the connecting means. Wires embedded in the plastic interlayer are used to provide the electrical connection to each transducer as shown in FIG. 10B.

Embodiments 9, 10, 11 and 12 are the same as 1, 2, 3 and 4 with the exception of the connecting means. Two flexible printed circuits with four transducers each are used to provide the electrical connection to the transducers as shown in FIG. 11A.

Embodiments 13, 14, 15 and 16 are the same as 1, 2, 3 and 4 with the exception of the connecting means. LASER ablated conductive coating is used to provide the electrical connection to the transducers as shown in FIG. 11B.

In some embodiments at least one electroacoustic transducer provides an active sound design.

In some embodiments at least one electroacoustic transducer provides active noise cancellation.

In some embodiments at least one electroacoustic transducer provides vibration that helps removing dust, debris, snow, water, or particles, at the surface of the glass.

It must be understood that the present disclosure is not limited to the embodiments described and illustrated, as it will be obvious for an expert on the art, there are different variations and possible modifications that do not strive away from the disclosure's essence, which is only defined by the following claims.

What is claimed is:

1. An automotive laminate, comprising:
at least two glass layers, each glass layer having oppositely major faces;
at least one plastic bonding interlayer positioned between the major faces of said at least two glass layers; and
at least one electroacoustic transducer positioned between said at least two glass layers and bonded to at least one of the glass layers.

2. The automotive laminate of claim 1, wherein the thickness of the at least one electroacoustic transducer is less than 1.5 mm.

3. The automotive laminate of claim 1, wherein the thickness of the at least one electroacoustic transducer is less than 1.0 mm.

4. The automotive laminate of claim 1 wherein the thickness of the at least one electroacoustic transducer is less than 0.5 mm.

5. The automotive laminate of claim 1, wherein the at least one electroacoustic transducer is bonded to the glass by means of an adhesive density matched to the glass.

6. The automotive laminate of claim 1, wherein the at least one electroacoustic transducer is positioned between two plastic bonding interlayers of said at least one plastic bonding interlayer.

7. The automotive laminate of claim 1, wherein the at least one electroacoustic transducer is placed in a hole in one or more layers of the at least one plastic bonding interlayer.

8. The automotive laminate of claim 1, wherein the at least one electroacoustic transducer provides active noise cancellation.

9. The automotive laminate of claim 1, wherein the at least one electroacoustic transducer reproduces high frequency audible sound.

10. The automotive laminate of claim 1, wherein the at least electroacoustic transducer provides alerts, warnings, and directions.

11. The automotive laminate of claim 1, wherein the at least one electroacoustic transducer provides sound sources for an active sound design system.

12. The automotive laminate of claim 1, wherein the at least one electroacoustic transducer is electrically connected by means of an individual cable.

13. The automotive laminate of claim 1, wherein the at least one electroacoustic transducer is electrically connected by means of an embedded wire. 14. The automotive laminate of claim 1, wherein the at least one electroacoustic transducer is electrically connected by means of a conductive coating.

15. The automotive laminate of claim 1 wherein the at least one electroacoustic transducer is electrically connected by means of a flexible circuit.

16. The automotive laminate of claim 1 wherein at least one electroacoustic transducer provides vibration that helps removing dust, debris, water, snow, mud, or particles, at the surface of the glass.
